(19) United States
(12) Patent Application Publication
(10) Pub. No.: US 2018/0361318 A1
(43) Pub. Date: Dec. 20, 2018

(54) CHANNEL MATERIAL

(71) Applicant: TORAY INDUSTRIES, INC., Tokyo (JP)

(72) Inventor: Kenko YAMADA, Osaka-shi (JP)

(73) Assignee: TORAY INDUSTRIES, INC., Tokyo (JP)

(21) Appl. No.: 16/060,546

(22) PCT Filed: Jan. 25, 2017
(86) PCT No.: PCT/JP2017/002544

§ 371 Date: Jun. 8, 2018

(30) Foreign Application Priority Data
Jan. 29, 2016 (JP) 2016-015152

(51) Int. Cl. B01D 61/02; B01D 63/10; D04B 21/20

(52) U.S. Cl. CPC B01D 61/025; B01D 63/10; D04B 21/20; D10B 2331/02; D10B 2401/041; D10B 2505/04; D10B 2331/04

(57) ABSTRACT

An object of the present invention is to provide a channel material which, when introduced as a liquid separation membrane module, is capable of retaining the salt removal rate of a separation membrane even when a high pressure acts from the supply side through a reverse osmosis separation membrane, and which has a small thickness.

The channel material is a channel material for a liquid separation membrane module which includes a tricot fabric formed by knitting synthetic fibers. The tricot fabric has a convex portion formed by a double loop, and the long side length of an opening formed inside the double loop is 50 to 260 μm. In addition, in the liquid separation membrane module, at least the reverse osmosis separation membrane and the channel material are wound around a central tube.

### TECHNICAL FIELD

The present invention relates to a channel material that can be used for a liquid separation membrane module including a reverse osmosis separation membrane.

### BACKGROUND ART

As a liquid separation membrane module including a reverse osmosis separation membrane (hereinafter, sometimes referred to as a “RO separation membrane”), a spiral type has been heretofore widely known. The structure of the liquid separation membrane module of spiral type is formed such that a channel material for a permeate liquid is sandwiched between reverse osmosis separation membranes, a channel material for a supply liquid is disposed outside the RO separation membrane to form a set of units, and a set of the units or a plurality of sets of the units are wound around the periphery of a hollow central tube.

At the time of using such a liquid separation membrane module, a differential pressure of 4 to 5 MPa acts on the supply liquid side and the permeate liquid side, and a channel material should not be deformed even when such a pressure acts.

Examples of the channel material on the permeate liquid side include those described below.

As a channel material that has been known for a long time, mention is made of a first conventional technique in which a fabric stitch portion is knitted with two sets of small-size thermoplastic synthetic filament yarns by a tricot knitting machine having 3 guide bars, and a set of large-size thermoplastic synthetic fiber filament yarns are inserted in a needle loop of the fabric stitch portion to knit a tricot fabric provided with a wale. The yarns of the tricot fabric are bonded together by heat treatment to rigidify the whole fabric (Patent Document 1).

As a comparative product described in Patent Document 1, a channel material obtained by knitting a double tricot fabric with a 2 guide bars-tricot using a mixture of thermoplastic synthetic fiber filament yarns, and subjecting the double tricot fabric to thermal bonding processing is used, and this comparative product has the problem that flow resistance is high, and the thickness cannot be reduced. Thus, in the invention in Patent Document 1, a yarn with a size larger than that of a yarn forming a fabric stitch portion is further knitted by a tricot knitting machine having 3 guide bars to provide a channel material capable of retaining a channel structure for a long period of time without impairing permeate liquid productivity.

As a second conventional technique, a channel material has been proposed in which using a bicomponent yarn as a thermoplastic synthetic fiber filament yarn and using a tricot knitting machine having 2 guide bars, tricot fabrics including a fabric stitch and a convex portion are formed, and bonded to each other by thermal bonding to rigidify the whole fabric (Patent Document 2).

Patent Document 2 discloses a technique in which excellent adhesiveness of a bicomponent yarn with a high-melting-point component disposed on the core side and a low-melting-point component disposed on the sheath side is utilized, and a fabric stitch and a convex portion are formed from bicomponent yarns with substantially the same size to provide a thin channel material which retains a channel material structure and rigidity for a long period of time, and does not cause elution without increasing channel resistance and impairing permeate liquid.

In addition, as a third conventional technique, a shaped sheet-like channel material rather than a tricot fabric channel material has been proposed (Patent Document 3). In this technique, a polyester film is subjected to imprint processing, or molding processing such as injection molding or compression molding to provide a shaped sheet-like channel material having continuous grooves arranged in one direction.

The comparative example described in the patent document 3 shows a tricot obtained by knitting polyester fiber multifilaments into double tricot stitches, and thermally bonded the stitches, and then performing calendar processing, and the tricot of the comparative example is poor in quality with a small permeate water amount and a low salt removal rate. Thus, in the invention in Patent Document 3, the channel material is a shaped sheet-like material, so that the groove width can be reduced without increasing the thickness, and the groove depth can be increased, and therefore collapse of a reverse osmosis membrane can be suppressed to obtain a liquid separation element having small channel resistance.

### PRIOR ART DOCUMENTS

### Patent Documents

Patent Document 1: Japanese Patent Laid-Open Publication No. 60-19001

Patent Document 2: Japanese Patent Laid-open Publication No. 2000-354743

Patent Document 3: Japanese Patent Laid-open Publication No. 2006-247453

### SUMMARY OF THE INVENTION

### Problems to be Solved by the Invention

In the first conventional technique, a tricot knitting machine having 3 guide bars is used for obtaining a channel material having lower flow resistance and a smaller thickness as compared to a channel material obtained by knitting a double tricot fabric with a 2 guide bars-tricot, and performing thermal bonding processing. A fabric stitch portion is knitted with two sets of small-size thermoplastic synthetic filament yarns, and a set of large-size thermoplastic synthetic fiber filament yarns are inserted in a needle loop portion of the fabric stitch portion to form a wale. However, in addition to two sets of small-size yarns, large-size yarns are inserted, and therefore the height of the wale can be increased, but since large-size yarns are also inserted in the fabric stitch, it is difficult to reduce the total thickness of the tricot fabric.

In addition, in the second conventional technique, a fabric stitch and a convex portion can be formed by providing back half stitches knitted as [1-0/1-2] with a front guide bar and knitted as [2-3/1-0] with a back guide bar, but in the [2-3/1-0] cord-knitted stitches knitted with the back guide bar, loops are linked in such a manner that one loop is absent between loops, and therefore there is the problem that the area of a channel with a large number of yarns existing in a water flow channel, leading to an increase in water passage resistance. In addition, in [2-3/1-0], the distance between loops is long, and therefore there is a problem in dimensional stability.

In addition, the third conventional technique proposes a sheet-like material that is shaped so that the amount of permeate water is increased, and the salt removal rate is improved as compared to a tricot obtained by knitting polyester fibers into double tricot stitches, thermally bonding the stitches, and performing calendar processing. However, the adhesive strength between an imprint-processed portion and a polyester film portion at the time of subjecting a polyester film to imprint processing is not sufficient. Thus, there is high demand for improving durability during use for liquid separation.

The present invention has been made in view of the problems of conventional techniques, and an object of the present invention is to provide a channel material which is capable of retaining the salt removal rate of a separation membrane even when a high pressure of a stock solution acts from the supply side through a reverse osmosis separation membrane during use, and which has a small thickness.

### Solutions to the Problems

For solving the problems, the present invention includes any of the following constitutions:

(1) a channel material for a liquid separation membrane module which includes a tricot fabric formed by knitting synthetic fibers, wherein the tricot fabric has a convex portion formed by a double loop, and the long side length of an opening formed inside the double loop is 50 to 260 □m;
(2) the channel material according to the above item, wherein the distance between the convex portions of the tricot fabric is within a range of 80 to 330 □m;
(3) the channel material according to either of the above items, wherein the distance between the convex portions of the tricot fabric is within a range of 290 to 330 □m;
(4) the channel material according to either of the above items, wherein the tricot fabric has a wale count of 35 to 45/2.54 cm, and a course count of 35 to 55/2.54 cm;
(5) the channel material according to either of the above items, wherein the tricot fabric is formed by closed loops of a double tricot stitch;
(6) the channel material according to either of the above items, wherein the synthetic fibers are thermally bonded together;
(7) the channel material according to either of the above items, wherein the synthetic fiber is a bicomponent filament yarn, and a sheath component includes a component having a melting point or softening point lower than that of a core component;
(8) the channel material according to either of the above items, wherein the synthetic fiber has a size of 30 to 90 dtex;
(9) a liquid separation membrane module including the channel material according to either of the above items;
(10) the liquid separation membrane module according to the above item, wherein the liquid separation membrane module further includes a reverse osmosis separation membrane, and the channel material is sandwiched between the reverse osmosis separation membranes;
(11) the liquid separation membrane module according to either of the above items, wherein the reverse osmosis separation membrane is held by a convex portion formed by a double loop of the channel material;
(12) the liquid separation membrane module according to either of the above items, wherein at least the reverse osmosis separation membrane and the permeation-side channel material are wound around a central tube; and
(13) a method for producing the channel material according to either of the above items, the method including knitting synthetic fibers with closed loops of a double tricot stitch, knitting the synthetic fibers with a front yarn runner length of 120 to 140 cm/R and a back yarn runner length of 115 to 130 cm/R in formation of a convex portion by a double loop, and then thermally bonding the fibers together by heat setting to form a fabric.

The “runner length” refers to the length (cm) of the yarn that is used for knitting of 480 courses (=1 rack (R)).

### Effects of the Invention

According to the present invention, it is possible to obtain a channel material capable of retaining a salt removal rate even when a high pressure acts on the supply side, i.e. the stock solution side, through a reverse osmosis separation membrane during use.

### BRIEF DESCRIPTION OF THE DRAWINGS

FIG. 1 is a schematic perspective view showing one example of a spiral-type liquid separation membrane module. The liquid separation membrane module is partially cut for understanding of the inside.

FIG. 2 is an enlarged photograph showing a shape of a fiber as seen from the convex portion side of a channel material for illustrating a long side of an opening formed inside a double loop.

FIG. 3 is a conceptual cross-sectional view of a channel material for illustrating a portion where a groove width and a groove depth in a channel are measured.

### EMBODIMENTS OF THE INVENTION

Embodiments of the present invention will be described below. A channel material of the present invention is a tricot fabric formed by knitting synthetic fibers. The tricot fabric has a convex portion formed by a double loop, and the long side length of an opening formed inside the double loop is within a range of 50 to 260

The tricot fabric includes a fabric stitch and a convex portion, and has the convex portion formed by a double loop. For forming the double loop, a tricot knitting machine having at least 2 guide bars is used, at least two sets of warps composed of synthetic fibers are used, a needle loop portion of a fabric stitch is formed with at least a set of warps used as back yarns, and at least the other set of warps are knitted as a front yarn in the needle loop portion of the fabric stitch to form a convex portion. At least two sets of warps composed of synthetic fibers may be of the same type or of different types, and when a double warp knitted fabric is formed, a fabric stitch and a convex portion can be formed. When the channel material of the present invention is disposed on the permeation side of the reverse osmosis separation membrane, the RO separation membrane is held by the convex portion formed by the double loop. Even when a pressure on the supply side acts during use, the RO separation membrane does not fall into a channel formed between the adjacent convex portions in the fabric, and a permeated liquid passes through a space formed by the fabric stitch and the convex portion.

In the convex portion formed by the double loop as described above, an opening exists inside the double loop, and this opening acts as a channel through which a permeate liquid filtered by the RO separation membrane passes. When the long side length of the opening is 50 μm or more, it is possible to reduce the passage resistance of the permeate liquid. In addition, the double loop has a function of holding the RO separation membrane by the convex portion when water pressure acts during use, and when the long side length of the opening is 260 μm or less, the RO separation membrane does not fall under water pressure, and channel resistance can be reduced. For these reasons, the long side length of the opening is preferably within a range of 50 to 260 μm. More preferably, the long side length of the opening is within a range of 230 to 260 μm for ensuring that the passage resistance of a permeate liquid is kept low, and the RO separation membrane is inhibited from falling under water pressure.

In the channel material of the present invention, the distance between convex portions (hereinafter referred to as a “groove width”) is preferably within a range of 80 to 330 μm. The groove width is preferably 80 μm or more because the passage resistance of the permeate liquid can be reduced, and the groove width is preferably 330 μm or less because the RO separation membrane does not fall. The groove width is more preferably within a range of 290 to 330 μm.

The groove width is determined by the wale count of the tricot fabric, the size of synthetic fibers forming the double loop, the expansion and course count of the double loop, and so on, and the wale count of the tricot fabric is preferably within a range of 35 to 45/2.54 cm. The wale count of the tricot fabric is preferably 35/2.54 cm or more because the distance between double loops decreases, so that the RO separation membrane does not fall, and the wale count of the tricot fabric is preferably 45/2.54 cm or less because there is a necessary distance between double loops, so that the passage resistance of the permeate liquid can be kept low.

In addition, the course count of the tricot fabric is preferably within a range of 35 to 55/2.54 cm. The course count of the tricot fabric is preferably 35/2.54 cm or more because the long side length of the opening formed inside the double loop can be set to 50 μm or more, so that it is possible to reduce the passage resistance of the permeate liquid. In addition, the course count of the tricot fabric is preferably 55/2.54 cm or less because the long side length of the opening formed inside the double loop can be set to 260 μm or less, so that the RO separation membrane does not fall under water pressure during use, and channel resistance can be reduced. For ensuring that the long side length of the opening formed inside the double loop is within a range of 230 to 260 the course count is more preferably within a range of 40 to 50/2.54 cm.

In addition, examples of the stitch of the tricot fabric according to the present invention may include half tricot stitches, back half tricot stitches and queens cord stitches, but double tricot stitches are preferable. This is because when a double tricot stitch is employed, the number of yarns forming a fabric stitch of a double warp knitted fabric can be reduced, so that the permeate water channel can be widened. In addition, a double tricot stitch formed of a tricot stitch on both the front and the back is preferable because the distance between loops is short on both the front and the back, so that excellent dimensional stability is exhibited. In addition, the distance between loops is short, and even when a fabric is formed using a small amount of fibers, it is possible to endure water pressure during use.

In addition, a fabric formed by closed loops of the double tricot stitch is preferable. As a method for forming a loop, mention is made of a closed loop and an open loop, but a closed loop is preferable because the expansion of synthetic fibers forming a double loop can be reduced, so that a necessary distance can be secured between double loops, and resultantly, the passage resistance of the permeate liquid can be kept low.

Preferably, the synthetic fibers forming the double loop are thermally bonded together. A configuration in which synthetic fibers are thermally bonded, and solidified is preferable because even when water pressure during use acts, fibers of the channel material are solidified and integrated, deformation or breakage does not occur, and deformation of convex portions of the fabric forming the channel material is small, and therefore the passage resistance of the permeate liquid can be kept low.

Examples of synthetic fibers to be used for the tricot fabric according to the present invention include polyamide fibers of nylon 6, nylon 66 and the like, polyester fibers, polyacrylonitrile fibers, polyolefin fibers of polyethylene, polypropylene and the like, and polyvinyl chloride fibers, and in particular, polyester fibers are suitably used because these fibers have sufficient strength even in an environment under water pressure during use, and the amount of components eluted into the permeate liquid is small.

In the case of, for example, polyester fibers, it is preferable that the polyester fibers are composed of two or more kinds of polyesters having different melting points or softening points. This is because when a channel material is formed of a polyester having a high melting point (hereinafter, abbreviated as a “polyester H”) and a polyester having a low melting point (hereinafter, abbreviated as a “polyester L”), the polyester H exhibits sufficient strength even in an environment under water pressure during use, and when the polyester L and the polyester H are thermally bonded together, and solidified, the fibers are solidified and integrated together.

As an aspect in which the polyester fibers are composed of two or more kinds of polyesters having different melting points or softening points, for example, mixed yarns including filament yarns, or sheath-core-type or side-by-side-type composite fibers are used. Rather than mixed yarns in which the polyester H and the polyester L are mixed in the form of filament single yarns, yarns in which filament single yarns are bicomponent yarns composed of the polyester H and the polyester L, and the sheath component includes a component having a melting point or softening point lower than that of the core component are preferable because the ratio of the polyester L can be increased, so that the number of melting points for thermal bonding can be increased.

Since the liquid separation membrane module may be washed with hot water before use, the melting point or softening point of the polyester L may be at least 80° C. or more, preferably at least 110° C. or more for withstanding the hot water washing.

The difference in melting point between the polyester H and the polyester L in the present invention is preferably at least 10° C., more preferably 20° C. or more. In the present invention, the difference in softening point when there is no melting point and there is a softening point is also referred to as a difference in melting point. When the difference in melting point is 20° C. or more, it is easy to solidify the fibers together by bonding only the polyester L while maintaining the shape of the convex portion. The upper limit of the difference in melting point is not limited as long as a channel material capable of giving a practical liquid separation membrane module can be obtained, but the upper limit is 180° C. from practical point of view.

Examples of the polyester H include polyethylene terephthalate, polybutylene terephthalate and polytrimethylene terephthalate having an alkylene terephthalate as a main repeating unit. By, for example, copolymerizing the polyester L with the polyester having an alkylene terephthalate as a main repeating unit, a difference in melting point can be generated. Examples of the component to be copolymerized include isophthalic acid, phthalic anhydride and diethylene glycol, and a component with which the differences in melting point is 10° C. or more is appropriately selected, and used.

The combination ratio of the polyester H and the polyester L may be appropriately selected, and is preferably in a range of 50:50 to 95:5 in terms of a weight ratio because thermal bonding can be sufficiently performed, and the fiber strength and the shrinkage ratio can be each set within a desired range. The combination ratio is more preferably 70:30 to 90:10.

For other fibers such as polyamide fibers, mixed yarns including filament yarns including two or more kinds of fibers having different melting points or softening points, or sheath-core-type or side-by-side-type composite fibers can be used as in the case of the polyester fibers.

The size of the synthetic fiber to be used for the tricot fabric according to the present invention is preferably within a range of 30 to 90 dtex. When a size in this range is selected, and the fibers are knitted into a double warp knitted fabric, it is possible to obtain a tricot fabric having a small thickness and a wide channel through which a permeate liquid passes. The size of the synthetic fiber is preferably 90 dtex or less because the roughness of the fabric stitch can be moderately suppressed, so that even when water pressure during use acts on protruding portions of the fabric stitch, sufficient passage for a permeate liquid can be secured. In addition, the size of the synthetic fiber is preferably 30 dtex or more because the height of the convex portion can be increased, so that a sufficient channel can be provided.

The size of the synthetic fiber is more preferably within a range of 40 to 60 dtex, and when the size of the synthetic fiber is within this range, the above-mentioned effect is further exhibited. In addition, it is preferable that the fabric is knitted with synthetic fibers having a size falling within this range because it is possible to ensure that the total thickness of the channel material is 210 to 260 μm, more preferably 210 to 230 μm, so that the number of laminated layers per unit can be increased, and even when water pressure acts, it is possible to sufficiently secure the passage rate of a permeate liquid.

As synthetic fibers to be used for the tricot fabric, those having different sizes may be used.

When fibers having different sizes, it is preferable that the size of the front yarn forming the needle loop portion of the convex portion is larger than the size of the back yarn forming the needle loop portion of the fabric stitch. This makes it possible to reduce the total thickness of the channel material while increasing the height of the convex portion to secure a sufficient liquid passage rate. The size of the back yarn forming the needle loop portion of the fabric stitch is preferably 30 to 60 dtex because the total thickness of the tricot fabric can be reduced while the passage rate of a permeate liquid is sufficiently secured. The size of the front yarn forming the needle loop of the convex portion is preferably 40 to 90 dtex.

The method for producing the tricot fabric according to the present invention is preferably the following method.

Synthetic fibers are knitted with closed loops of a double tricot stitch, and the synthetic fibers are knitted with a front yarn runner length of 120 to 140 cm/R and a back yarn runner length of 115 to 130 cm/R in formation of a convex portion by a double loop. The resultant knitted fabric is heat-set to thermally bond the fibers. The double tricot stitch can be knitted by using a tricot knitting machine including at least 2 guide bars, where a front yarn and a back yarn are supplied to a front guide bar and a back guide bar, respectively. The runner length at the time of knitting is a main condition for determining the loop shape and course count of the tricot stitch, and it is preferable to knit fibers with a front yarn runner length of 120 to 140 cm/R and a back yarn runner length of 115 to 130 cm/R. It is preferable that fibers are knitted with a front yarn runner length of 120 to 140 cm/R because the loops of synthetic fibers forming a double loop can be made small, and the yarn tension during knitting is within a proper range, so that the frequency of contact of synthetic fibers with a guide or yarn breakage is low, thus making it possible to stably perform knitting. In addition, it is preferable that fibers are knitted with a back yarn runner length of 115 to 130 cm/R because the yarn tension during knitting is within a proper range, so that the frequency of contact of synthetic fibers with a guide or yarn breakage is low, thus making it possible to stably perform knitting. It is preferable that the front yarn runner length is set longer than the back yarn runner length in formation of a double loop because the amount of the front yarn relatively increases as compared to the amount of the back yarn, so that the height of the convex portion is increased, thus making it possible to increase the passage area of a permeate liquid.

When fibers are knitted with a front yarn runner length of 120 to 140 cm/R and a back yarn runner length of 115 to 130 cm/R as described above, the long side length of the opening formed inside the double loop can be set within a range of 50 to 260 μm.

The thus-obtained tricot fabric of the double tricot stitch is heat-set to thermally bond fibers, so that a tricot fabric according to the present invention can be obtained. When the synthetic fiber to be used is a bicomponent filament yarn, it is preferable that the sheath component includes a component having a melting point or softening point lower than that of the core component. This is because existence of a component having a low melting point or softening point makes it easy to thermally bond fibers by heat-setting. The heat-setting method is not particularly limited as long as a double loop specified in the present invention can be obtained, and a usual pin tenter dryer or cylinder dryer may be used, but a pin tenter dryer, in which the width is easily set, is suitably used. When synthetic fibers having a melting point or softening point of 170 to 240° C. are used, it is preferable that the set temperature of the pin tenter dryer is a temperature higher by 5° C. or more, preferably higher by 10° C. or more, than the melting point or softening point because thermal bonding of fibers can be promoted. The upper limit of the set temperature is preferably higher by about 30° C. or less than the melting point or softening point from the viewpoint of economy and for making it possible to stably control the temperature of the dryer.

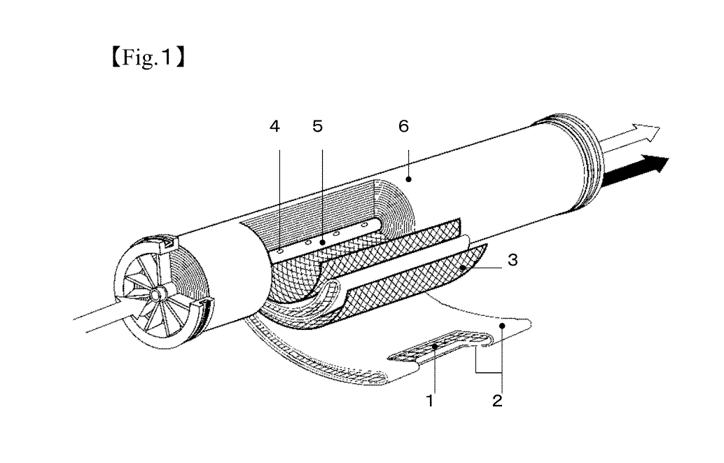

The thus-obtained tricot fabric of the present invention can be used as a channel material for a liquid separation membrane module. In particular, the tricot fabric can be suitably used in a liquid separation membrane module for production of pure water and ultrapure water, softening of water, recovery of waste water, recovery of valuable substances and the like. The channel material of the present invention can be particularly suitably used in a liquid separation membrane module for cleaning of fresh water in which fresh water is filtered to obtain industrial water because even when a stock solution applies a high pressure of 4 to 5 MPa through a RO separation membrane during use, a high salt removal rate can be secured. Preferably, the liquid separation membrane module has a structure in which at least a reverse osmosis separation membrane and a permeation-side channel material are wound around a central tube. That is, a spiral-type liquid separation membrane module is preferable. FIG. 1 is a schematic perspective view showing one example of a spiral-type liquid separation membrane module. In a liquid separation membrane module 6, a permeate liquid-side channel material 1 is sandwiched between two RO separation membranes 2. Further, a supply liquid passage channel material 3 is disposed on the RO separation membrane 2 on a side opposite to the permeation-side channel material 1. A mesh can be used as a supply liquid passage channel material. As a result, a unit including supply liquid-side passage channel material, a RO separation membrane, a permeate liquid-side channel material and a RO separation membrane is formed. One set of the units or a plurality of sets of the units are wound around a hollow central tube 5 having a water collecting hole 4 to form a liquid separation membrane module. A case may exist at the outermost portion of the liquid separation membrane module. It is preferable to use the tricot channel material of the present invention for a permeation-side channel material for forming a channel through which the permeate liquid passes.

### EXAMPLES

Hereinafter, the present invention will be described by way of examples, but the present invention is not necessarily limited to these examples. Methods for measurement of various properties and criteria for overall evaluation as used in the examples are as follows.

[Method for Measurement of Properties]

In the following measurement methods, adjustment of samples and measurement were performed in the standard state (20±2° C., relative humidity: 65±4%) in JIS-L-0105 (2006) unless otherwise specified.

(1) Long Side Length of Opening Inside Double Loop (μm)

Using a digital microscope VHX-5000 manufactured by Keyence Corporation, observation was performed at a magnification of 100 times, and the long side length of an opening formed inside a double loop was measured. In the measurement, one point was randomly extracted at a center in the width, measurement was performed with 12 double loops, and the average thereof was determined.

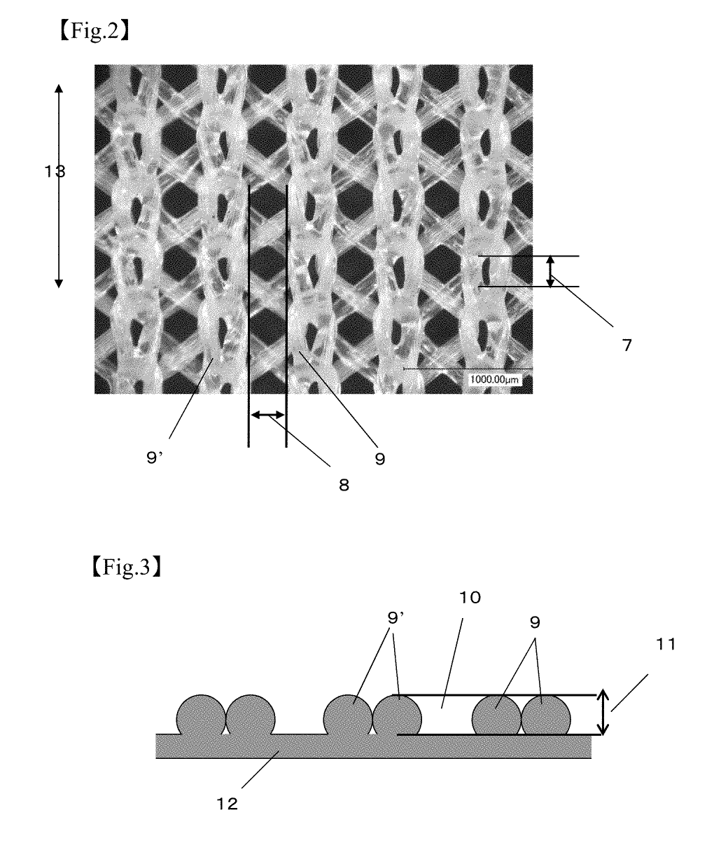

The long side of the opening formed inside the double loop is illustrated in FIG. 2. This is a view of a tricot channel material as seen from the convex portion side. In FIG. 2, a double loop 9 forms a convex portion, and the opening exists inside the double loop. The width of the opening in a stitch direction was set to a long side length 7.

(2) Count (Number/2.54 cm)

In accordance with Annex F in JIS-L-1096 (2010), the number of wales and the number of courses in the tricot channel material were measured using a densimeter.

(3) Thickness (mm)

The thickness of the channel material of the tricot fabric was measured using a Peacock dial gauge (manufactured by Ozaki Seisakusho Co., Ltd., model: H, scale: 0.01 mm, gauge head diameter: 10 mmφ).

(4) Channel Groove Width (μm) and Channel Groove Depth (μm)

Using a digital microscope VHX-5000 manufactured by Keyence Corporation, observation was performed at a magnification of 100 times, and the channel groove width and the channel groove depth were measured. In measurement of the channel groove depth, the channel material was cut perpendicularly to a stitch direction, and the resulting cross-section was observed at the same magnification as described above. The groove width and the groove depth were defined as those shown in FIGS. 2 and 3. In the measurement, three points were randomly extracted from the whole width, measurement was performed five times for each of the points, and the average thereof was determined.

FIG. 2 is an enlarged photograph showing a double loop as seen from the convex portion side of the channel material, and illustrates a method for measurement of the channel groove width. FIG. 3 is a conceptual cross-sectional view of a tricot channel material, and illustrates a method for measurement of the channel groove depth. In FIG. 2, a plurality of double loops 9 are continuously arranged in a longitudinal direction. Assume a tangent line at a portion where these double loops most greatly expand. In addition, in FIG. 2, a plurality of double loops 9′ also exist away from, but most close to, the loops 9 in a lateral direction. Similarly, assume a tangent line for a plurality of double loops 9′. The distance between the two tangent lines was defined as the groove width 8 of the channel. In FIG. 3, a portion surrounded by a line connecting the top of the double loop 9 and the top of the double loop 9′ in the channel material and a fabric stitch 12 of the channel material forms a permeate liquid passage portion 10. The distance between the fabric stitch 12 and the line connecting the top of the double loop 9 and the top of the double loop 9′ was defined as a channel groove depth 11.

(5) Water Resistance Test (Salt Removal Rate (%), Water Production Amount (m³/day))

A tricot channel material was sandwiched between two 150 μm-thick RO separation membranes. As shown in FIG. 1, a unit of spiral type was formed, and introduced into a module case having a diameter of 0.2 m and a length of 1 m, so that a liquid separation membrane module was prepared. Seawater having 3.5% by weight of TDS (soluble evaporation residues) was filtered at a liquid temperature of 25° C. under a differential pressure of 4.5 MPa for 5 days. After elapse of 5 days, the electric conductivity of the permeate liquid was measured, and the magnesium sulfate salt removal rate was calculated. A sample with a removal rate of 99.8% or more was rated acceptable. In addition, the amount of a permeate liquid after elapse of 5 days was measured, and the water production amount per day was calculated.

### Example 1

A bicomponent filament yarn I (24 filaments, 56 decitex) with polyethylene terephthalate (melting point: 255° C.) disposed as a core and a polyethylene terephthalate-based low-melting-point polyester (melting point: 225° C.) disposed as a sheath was used as a front yarn, and a regular original yarn I (18 filaments, 56 decitex) composed only of polyethylene terephthalate (melting point: 255° C.) was used as a back yarn. These yarns were knitted into a double tricot stitch of closed loops using 2 guide bars of a 32-gauge tricot knitting machine (the number of needles between unit lengths in the knitting machine is 32). Here, the bicomponent filament yarn I was fed as a front yarn to a front guide bar with a runner length of 124 cm/R, and the regular original yarn I was fed as a back yarn to a back guide bar with a runner length of 121 cm/R to form a fabric having a fabric stitch and convex portions. Thereafter, the fabric was heat-set for 1 minute in a pin tenter processing machine set at 245° C., so that a tricot fabric channel material A having a wale count of 40/2.54 cm and a course count of 50/2.54 cm was obtained.

In the obtained tricot fabric channel material A, the long side length of an opening inside a double loop was 258 μm.

### Example 2

A multifilament mixed filament yarn I (36 filaments, 84 decitex) formed by mixing a polyethylene terephthalate-based low-melting-point polyester filament (melting point: 225° C.) with a polyethylene terephthalate filament (melting point: 255° C.) was used as a front yarn, and the regular original yarn I used in Example 1 was used as a back yarn. These yarns were knitted into a double tricot stitch of closed loops using 2 guide bars of a 32-gauge tricot knitting machine identical to that in Example 1. Here, the front yarn was fed with a runner length of 131 cm/R, and the back yarn was fed with a runner length of 121 cm/R to form a fabric having a fabric stitch and convex portions. Thereafter, the fabric was heat-set in the same manner as in Example 1 to obtain a tricot fabric channel material B having a wale count of 39/2.54 cm and a course count of 52/2.54 cm.

In the obtained tricot fabric channel material B, the long side length of an opening inside a double loop was 220

### Example 3

The multifilament mixed yarn I used in Example 2 was used as a front yarn, and the regular original yarn I used in Example 1 was used as a back yarn. These yarns were knitted into a double tricot stitch of closed loops using 2 guide bars of a 32-gauge tricot knitting machine identical to that in Example 1. Here, the front yarn was fed with a runner length of 138 cm/R, and the back yarn was fed with a runner length of 124 cm/R to form a fabric having a fabric stitch and convex portions. Thereafter, the fabric was heat-set in the same manner as in Example 1 to obtain a tricot fabric channel material C having a wale count of 39/2.54 cm and a course count of 46/2.54 cm.

In the obtained tricot fabric channel material C, the long side length of an opening inside a double loop was 245 μm.

### Comparative Example 1

The multifilament mixed yarn I used in Example 2 was used as a front yarn, and the regular original yarn I used in Example 1 was used as a back yarn. These yarns were knitted into a double tricot stitch of closed loops using 2 guide bars of a 32-gauge tricot knitting machine identical to that in Example 1. Here, the front yarn was fed with a runner length of 145 cm/R, and the back yarn was fed with a runner length of 129 cm/R to form a fabric having a fabric stitch and convex portions. Thereafter, the fabric was heat-set in the same manner as in Example 1 to obtain a tricot fabric channel material D having a wale count of 39/2.54 cm and a course count of 41/2.54 cm.

In the obtained tricot fabric channel material D, the long side length of an opening inside a double loop was 266 μm.

The removal rate of a magnesium sulfate salt in a water resistance test was 98.0%, and this result indicated that there was a risk of breaking the RO separation membrane. Therefore, the fabric was rated unacceptable.

### Comparative Example 2

The bicomponent filament yarn I used in Example 1 was used as a front yarn, and the regular original yarn I used in Example 1 was used as a back yarn. These yarns were knitted into a double tricot stitch of closed loops using 2 guide bars of a 32-gauge tricot knitting machine identical to that in Example 1. Here, the front yarn was fed with a runner length of 118 cm/R, and the back yarn was fed with a runner length of 118 cm/R to form a fabric having a fabric stitch and convex portions. Thereafter, the fabric was heat-set in the same manner as in Example 1 to obtain a tricot fabric channel material E having a wale count of 40/2.54 cm and a course count of 38/2.54 cm.

In both the bicomponent filament yarn I and the regular original yarn I, collision with a guide or yarn breakage frequently occurred during knitting, and there were many knitting defects.

In the obtained tricot fabric channel material E, the long side length of an opening inside a double loop was 348 μm.

In addition, the removal rate of a magnesium sulfate salt in a water resistance test was 99.5%, and evident breakage of the RO separation membrane was not observed, but the removal rate decreased with elapse of time. Therefore, the fabric was rated unacceptable.

### Example 4

The bicomponent yarn I used in Example 1 was used as a front yarn, and the regular original yarn I used in Example 1 was used as a back yarn. These yarns were knitted into half tricot stitch of closed loops using 2 guide bars of a 32-gauge tricot knitting machine identical to that in Example 1. Here, the front yarn was fed with a runner length of 161 cm/R to obtain a cord stitch of [2-3/1-0], and the back yarn was fed with a runner length of 114 cm/R to obtain a tricot stitch of [1-0/1-2], so a fabric having a fabric stitch and convex portions was formed. Thereafter, the fabric was heat-set in the same manner as in Example 1 to obtain a tricot fabric channel material F having a wale count of 40/2.54 cm and a course count of 52/2.54 cm.

In the obtained tricot fabric channel material F, the long side length of an opening inside a double loop was 251 μm.

### Example 5

The multifilament mixed yarn I used in Example 2 was used as a front yarn, and the regular original yarn I used in Example 1 was used as a back yarn. These yarns were knitted into a half stitch of closed loops using 2 guide bars of a 32-gauge tricot knitting machine identical to that in Example 1. Here, the front yarn was fed with a runner length of 167 cm/R to obtain a cord stitch of [2-3/1-0], and the back yarn was fed with a runner length of 121 cm/R to obtain a tricot stitch of [1-0/1-2], so a fabric having a fabric stitch and convex portions was formed. Thereafter, the fabric was heat-set in the same manner as in Example 1 to obtain a tricot fabric channel material F having a wale count of 38/2.54 cm and a course count of 50/2.54 cm.

In the obtained tricot fabric channel material G, the long side length of an opening inside a double loop was 259 μm.

TABLE 1

| | | | Example 1 | Example 2 | Example 3 |
|---|---|---|---|---|---|
| | | | Tricot fabric | Tricot fabric | Tricot fabric |
| | | | channel material | channel material | channel material |
| | | | A | B | C |
| Synthetic | Front yarn | | 56T-24FY | 84T-36FY | 84T-36FY |
| fiber | | | Bicomponent | Filament mixed | Filament mixed |
| | | | filament yarn I | fiber yarn I | fiber yarn I |
| | Back yarn | | 56T-18FY | 56T-18FY | 56T-18FY |
| | | | Regular yarn I | Regular yarn I | Regular yarn I |
| Tricot | Stitch | | Double tricot | Double tricot | Double tricot |
| fabric | | | Closed loop | Closed loop | Closed loop |
| channel | Runner length | Front | 124 | 131 | 138 |
| material | (cm/R) | Back | 121 | 121 | 124 |
| | Weight per unit area of | | 81 | 112 | 102 |
| | finished product (g/m²) | | | | |
| | Count of | Wale | 40 | 39 | 39 |
| | finished product | Course | 50 | 52 | 46 |
| | (number/2.54 cm) | | | | |
| | Long Side Length of Opening | | 258 | 228 | 245 |
| | Formed inside the Double Loop (mm) | | | | |
| | Thickness (mm) | | 0.24 | 0.26 | 0.25 |
| | Channel groove width (μm) | | 320 | 280 | 313 |
| | Channel groove depth (μm) | | 100 | 110 | 99 |
| | Water resistance | Salt removal rate (%) | 99.9 | 99.8 | 99.8 |
| | test | Water production | 48 | 47 | 52 |
| | | amount (m³/day) | | | |

TABLE 2

| | | | Comparative | Comparative | | |
|---|---|---|---|---|---|---|
| | | | Example 1 | Example 2 | Example 4 | Example 5 |
| | | | Tricot fabric | Tricot fabric | Tricot fabric | Tricot fabric |
| | | | channel material | channel material | channel material | channel material |
| | | | D | E | F | G |
| Synthetic | Front yarn | | 84T-36FY | 56T-24FY | 56T-24FY | 84T-36FY |
| fiber | | | Filament mixed | Bicomponent | Bicomponent | Filament mixed |
| | | | fiber yarn I | filament yarn I | filament yarn I | fiber yarn I |
| | Back yarn | | 56T-18FY | 56T-18FY | 56T-18FY | 56T-18FY |
| | | | Regular yarn I | Regular yarn I | Regular yarn I | Regular yarn I |
| Tricot | Stitch | | Double tricot | Double tricot | Half | Half |
| fabric | | | Closed loop | Closed loop | Closed loop | Closed loop |
| channel | Runner length | Front | 145 | 118 | 161 | 167 |
| material | (cm/R) | Back | 129 | 118 | 114 | 121 |
| | Weight per unit area of | | 93 | 94 | 101 | 124 |
| | finished product (g/m²) | | | | | |
| | Count of | Wale | 39 | 40 | 40 | 38 |
| | finished product | Course | 41 | 38 | 52 | 50 |
| | (number/2.54 cm) | | | | | |
| | Long Side Length of Opening | | 266 | 348 | 251 | 259 |
| | Formed inside the Double Loop (mm) | | | | | |
| | Thickness (mm) | | 0.26 | 0.25 | 0.26 | 0.30 |
| | Channel groove width (μm) | | 350 | 340 | 315 | 301 |
| | Channel groove depth (μm) | | 110 | 120 | 97 | 113 |
| | Water resistance | Salt removal rate (%) | 98.0 | 99.5 | 99.9 | 99.8 |
| | test | Water production | 49 | 43 | 50 | 51 |
| | | amount (m³/day) | | | | |

It is apparent from Table 1 that the channel material of the present invention can retain a high salt removal rate even when a pressure of 4.5 MPa acts. In particular, the fabric of Example 1 is lightweight and thin, but has a salt removal rate higher than that in comparative examples, and a water production amount equivalent to that in comparative examples. These results show that the fabric of Example 1 can be used even when high pressure of a stock solution acts through the RO separation membrane.

### DESCRIPTION OF REFERENCE SIGNS

1: Permeate liquid-side channel material
2: RO separation membrane
3: Supply liquid passage channel material
4: Water collecting hole
5: Central tube
6: Liquid separation membrane module
7: Long side length of opening
8: Channel groove width
9, 9′: Double loop
10: Permeable liquid passage portion
11: Channel groove depth
12: Fabric stitch of channel material
13: Stitch direction

1. A channel material for a liquid separation membrane module which comprises a tricot fabric formed by knitting synthetic fiber, wherein the tricot fabric has a convex portion formed by a double loop, and the long side length of an opening formed inside the double loop is 50 to 260 μm.

2. The channel material according to claim 1, wherein the distance between the convex portions of the tricot fabric is within a range of 80 to 330 μm.

3. The channel material according to claim 1, wherein the distance between the convex portions of the tricot fabric is within a range of 290 to 330 μm.

4. The channel material according to claim 1, wherein the tricot fabric has a wale count of 35 to 45/2.54 cm, and a course count of 35 to 55/2.54 cm.

5. The channel material according to claim 1, wherein the tricot fabric is formed by closed loops of a double tricot stitch.

6. The channel material according to claim 1, wherein the synthetic fibers are thermally bonded together.

7. The channel material according to claim 1, wherein the synthetic fiber is a bicomponent filament yarn, and a sheath component includes a component having a melting point or softening point lower than that of a core component.

8. The channel material according to claim 1, wherein the synthetic fiber has a size of 30 to 90 dtex.

9. A liquid separation membrane module comprising the channel material according to claim 1.

10. The liquid separation membrane module according to claim 9, wherein the liquid separation membrane module further includes a reverse osmosis separation membrane, and the channel material is sandwiched between the reverse osmosis separation membranes.

11. The liquid separation membrane module according to claim 9, wherein the reverse osmosis separation membrane is held by a convex portion formed by a double loop of the channel material.

12. The liquid separation membrane module according to claim 9, wherein at least the reverse osmosis separation membrane and the permeation-side channel material are wound around a central tube.

13. A method for producing the channel material according to claim 1, the method comprising knitting synthetic fibers with closed loops of a double tricot stitch, knitting the synthetic fibers with a front yarn runner length of 120 to 140 cm/R and a back yarn runner length of 115 to 130 cm/R in formation of a convex portion by a double loop, and then thermally bonding the fibers together by heat setting to form a fabric.
